(19) United States
(12) Patent Application Publication
(10) Pub. No.: US 2026/0079822 A1
(43) Pub. Date: Mar. 19, 2026

(54) POINT OF SALE PERIPHERAL DIAGNOSTICS SYSTEM

(71) Applicant: TOSHIBA GLOBAL COMMERCE SOLUTIONS, INC., Durham, NC (US)

(72) Inventors: Paul D. LINDSEY, Springdale, AR (US); Bradley T. MARCHESSEAULT, Cary, NC (US)

(21) Appl. No.: 18/890,030

(22) Filed: Sep. 19, 2024

(51) Int. Cl. G06F 11/36; G06Q 20/20

(52) U.S. Cl. CPC G06F 11/3688; G06Q 20/202

(57) ABSTRACT

A method for running a diagnostics web application for a peripheral device within a root web application running on a point of sale system operatively coupled to the peripheral device includes: loading, by the root web application, the diagnostics web application into a first iFrame of the root web application and loading an interface web application for the peripheral device into a second iFrame of the root web application; issuing, by the root web application, a command to the peripheral device using the interface web application; responsive to the command, receiving, at the interface web application, data from the peripheral device indicating occurrence of an error; and causing, by the root web application, a webpage of the diagnostics web application to display within a webpage of the root web application based on the data indicating occurrence of the error.

### BACKGROUND

Point of sale terminals may be deployed at a retail location and may be utilized by a customer or an employee (e.g., cashier) of the retail location. Point of sale terminals typically include a display screen that displays a user interface associated with a root web application (e.g., browser-based point of sale web application) that the customer or employee may interact to purchase items at the retail location. Point of sale terminals may interact with peripheral devices, such as a peripheral device configured to accept and/or dispense currency (e.g., cash, coin), that are typically controlled using a native application.

### BRIEF DESCRIPTION OF THE DRAWINGS

FIG. 1 depicts a block diagram of components of a point of sale system and a peripheral device communicatively coupled with the point of sale system according to one or more embodiments of the present disclosure.

FIG. 2 depicts a diagnostics web application for a peripheral device and an interface web application for the peripheral device as separate iFrames running within a root web application for a point of sale system according to one or more embodiments of the present disclosure.

FIG. 3 depicts a sequence diagram illustrating steps associated with displaying a webpage of a diagnostics web application for a peripheral device within a webpage of a root web application for a point of sale system according to one or more embodiments of the present disclosure.

FIG. 4A depicts a webpage of a root web application for a point of sale system according to one or more embodiments of the present disclosure.

FIG. 4B depicts a first webpage of a diagnostics web application for a peripheral device communicatively coupled with a point of sale system according to one or more embodiments of the present disclosure.

FIG. 4C depicts a second webpage of a diagnostics web application for a peripheral device communicatively coupled with a point of sale system according to one or more embodiments of the present disclosure.

FIG. 4D depicts a third webpage of a diagnostics web application for a peripheral device communicatively coupled with a point of sale system according to one or more embodiments of the present disclosure.

FIG. 5 depicts a flow diagram for a method according to one or more embodiments of the present disclosure.

### DETAILED DESCRIPTION

Example aspects of the present disclosure are directed to point of sale systems that are communicatively coupled to a peripheral device, such as a cash accepter/dispenser. Conventional point of sale systems interact with peripheral devices via a native application that is separate from a root web application running on the point of sale systems. Thus, to interact with peripheral devices, conventional point of sale systems typically stop/pause the root web application and run the native application to interact with peripheral devices. Then, once finished interacting with the peripheral devices, conventional point of sale systems typically restart/unpause the root web application. This process is cumbersome and wastes computing resources.

Example aspects of the present disclosure are directed to techniques for running a diagnostics web application for a peripheral device within a root web application for a point of sale system. For example, the disclosed techniques include loading the diagnostic web application into a first iFrame of the root web application and loading an interface web application (e.g., associated with facilitating communications between the diagnostic web application and one or more hardware components of the peripheral device) for the peripheral device into a second iFrame of the root web application. The diagnostics web application may generally be hidden from a user viewing the root web application, specifically webpages thereof, on a display screen of the point of sale system. However, when an error is present on the peripheral device, a user of the point of sale system may interact with the root web application (e.g., a webpage thereof) to navigate to the diagnostics web application to troubleshoot the error on the peripheral device. Furthermore, since the diagnostics web application is embedded within a dedicated iFrame of the root web application, a user can interact with the diagnostics web application to troubleshoot the error with the peripheral device without having to leave the root web application. In this manner, the disclosed techniques provided an improved approach for point of sale systems interacting with peripheral devices that is less cumbersome and better conserves computing resources of the point of sale system.

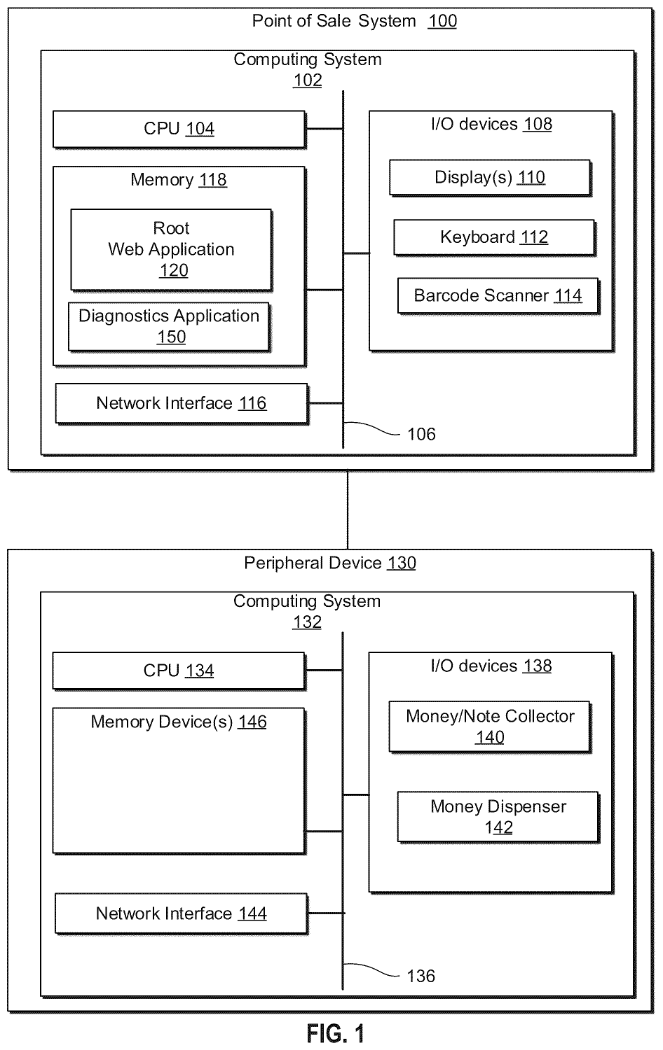

FIG. 1 illustrates a perspective view of an exemplary point of sale system 100 according to one or more embodiments of the present disclosure. In one example, the point of sale system 100 can be a self-service checkout kiosk.

As illustrated, the point of sale system 100 may include a computing system 102. The computing system 102 may include a central processing unit (CPU) 104, an I/O device interface 106 that may allow for the connection of various I/O devices 108 (e.g., display 110, keyboard 112, barcode scanner 114 etc.), a network interface 116, and a memory 118. It is contemplated that one or more components of the computing system 102 may include physical components or virtualized components.

The CPU 104 may retrieve and execute programming instructions stored in the memory 118. Similarly, the CPU 104 may retrieve and store data residing in the memory 118. The CPU 104 is included to be representative of a single CPU, multiple CPUs, a single CPU having multiple processing cores, and other arrangements.

Additionally, the memory 118 is included to be representative of a random access memory or the like. In some embodiments, the memory 118 may include a disk drive, solid state drive, or a collection of storage devices distributed across multiple storage systems. Although shown as a single unit, the memory 118 may be a combination of fixed and/or removable storage devices, such as fixed disc drives, removable memory cards or optical storage, network attached storage (NAS), or a storage area-network (SAN).

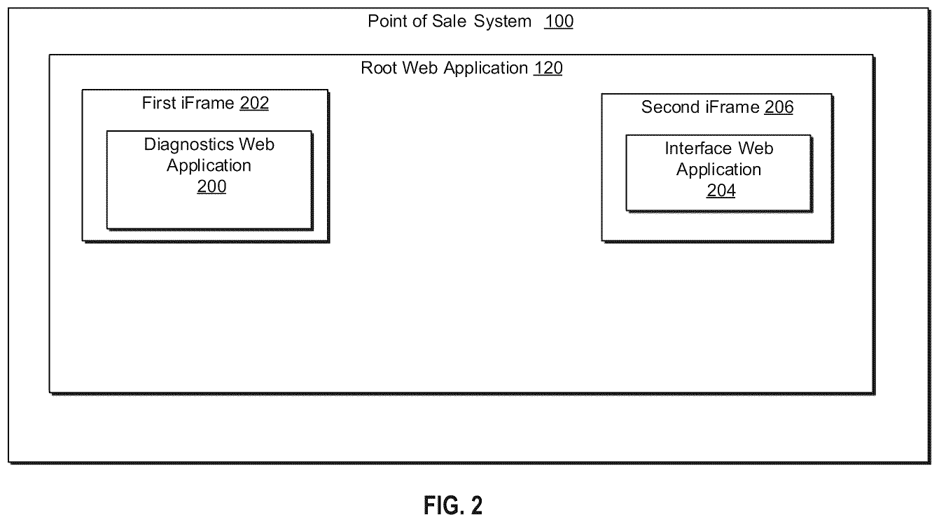

As shown, the memory 118 includes a root web application 120. The root web application 120 may include a webpage that is displayed to a user via the display 110. Additional details of the root web application 120 will be discussed in more detail with reference to FIG. 2.

It is noted that the computing system 102 is included as an example, and certain functionality described with respect to computing system 102 and/or otherwise described herein may be implemented via more or fewer devices and/or components. For example, in other embodiments of the present disclosure, the computing system 102 of the point of sale system 100 may include more or fewer I/O devices.

As illustrated, a peripheral device 130 may be communicatively coupled with the point of sale system 100. The peripheral device 130 may include a computing system 132 similar to the computing system 102 discussed above with reference to the point of sale system 100. For example, the computing system 132 may include a central processing unit (CPU) 134, an I/O device interface 136 that may allow for the connection of various I/O devices 138 (e.g., money/note collector 140, money dispenser 142 etc.), a network interface 144, and a memory 146. It is contemplated that one or more components of the computing system 132 may include physical components or virtualized components.

The CPU 134 may retrieve and execute programming instructions stored in the memory 146 to control operation of the peripheral device 130. Similarly, the CPU 134 may retrieve and store data residing in the memory 146. The CPU 134 is included to be representative of a single CPU, multiple CPUs, a single CPU having multiple processing cores, and other arrangements.

Additionally, the memory 146 is included to be representative of a random access memory or the like. In some embodiments, the memory 146 may include a disk drive, solid state drive, or a collection of storage devices distributed across multiple storage systems. Although shown as a single unit, the memory 146 may be a combination of fixed and/or removable storage devices, such as fixed disc drives, removable memory cards or optical storage, network attached storage (NAS), or a storage area-network (SAN).

It is noted that the computing system 132 is included as an example, and certain functionality described with respect to computing system 132 and/or otherwise described herein may be implemented via more or fewer devices and/or components. For example, in other embodiments of the present disclosure, the computing system 132 of the peripheral device 130 may include more or fewer I/O devices.

In operation, a user may interact with the point of sale system 100 to purchase one or more items. For example, a unique identifier (e.g., a barcode) affixed to the one or more items may be scanned (e.g. using the barcode scanner 114). As the one or more items are scanned, a webpage displayed on the display 110 and associated with the root web application 120 may be updated to reflect a total amount (e.g., cost) the user must pay to purchase the one or more items. In some embodiments, the user may interact with the peripheral device 130 to pay for the one or more items. For example, the user may deposit a note (e.g., a check) or currency (e.g., bills and/or coins) into the peripheral device 130 by placing the note or currency into the money/note collector 140 of the peripheral device 130. The peripheral device 130 may analyze the deposited note or currency to determine whether an amount the user submitted corresponds to the amount due for the one or more items.

In some embodiments, a user may interact with the webpage displayed on the display 110 and associated with the root web application 120 to request cash back. For example, the webpage may display one or more predefined amounts of money (e.g., $5, $10, $20, $100) that the user may request. It should be understood that the amount of money requested by the user may be deducted from a banking account (e.g., credit account, checking account) that the user uses to pay for the one or more items.

Maintenance operations may be performed on the peripheral device 130 at pre-defined intervals of time (e.g., weekly, monthly, quarterly, annually) or in response to a trigger event (e.g., an error event occurring in response to a user interacting with the peripheral device 130 to insert money via the money/note collector 140 or collect money via the money dispenser 142). Conventional point of sale systems 100 include a diagnostics application 150 for the peripheral device 130.

As illustrated, in some embodiments, the diagnostics application 150 for the peripheral device 130 may be stored in the memory 118 of the computing system 102 for the point of sale system 100. Furthermore, the diagnostics application 150 may be separate from the root web application 120 that users typically interact with when using the point of sale system 100. Thus, to perform maintenance on the peripheral device 130, a user stops (e.g., closes) the root web application 120 and starts (e.g., opens) the diagnostics application. Then, once the user finishes performing maintenance on the peripheral device 130, the user stops (e.g., closes) the diagnostics application 150 and restarts (e.g., reopens) the root web application 120 such that subsequent users may interact with the point of sale system 100 to scan and pay for purchased items.

The above-described method for performing maintenance on the peripheral device 130 is an inefficient use of computing resources. For example, navigating between the two different applications (e.g., root web application 120 and diagnostics application 150) is cumbersome to the user and an inefficient use of the computing system 102 of the point of sale system 100. Specifically, computing resources of the CPU 104 of the computing system 102 are wasted by generating multiple different webpages associated with the various steps (e.g., stopping the root web application, starting the diagnostics application, stopping the diagnostics application, and restarting the root web application). As will now be discussed, the present disclosure is directed to a technique for running the diagnostics application 150 within a dedicated iFrame of the root web application 120. By running the diagnostics application 150 as a dedicated iFrame within the root web application 120, a user may access the diagnostics application 150 within the root web application 120. In this manner, the disclosed technique provides a more efficient (e.g., less cumbersome) way for the user to access and interact with the diagnostics application 150. Additionally, the disclosed techniques improve computing resources by eliminating (or at least reducing) wasted computing resources associated with stopping the root web application 120, starting the diagnostics application 150, stopping the diagnostics application 150, and restarting the root web application 120.

FIG. 2 depicts a schematic illustrating a diagnostics web application 200 for a peripheral device running within a first iFrame 202 of the root web application 120 according to one or more embodiments of the present disclosure. The schematic also illustrates an interface web application 204 running within a second iFrame 206 of the root web application 120. The interface web application 204 may facilitate communication between the diagnostics web application 200 and the peripheral device.

It should be understood that the first iFrame 202 and the second iFrame 206 mentioned above refer to hypertext markup language (HTML) elements that allow a web page of the diagnostics web application 200 and a web page of the interface web application 204 to be included inside a web page associated with the root web application 120. In this manner, the diagnostics web application 200 can be accessed within the root web application 120. Also, as an example, the following HTML tag may be used to embed the diagnostics web application within the root web application 120:

<iframe id=“cashServiceIFrame” src=“http://www.xxx.com/cashService.html?deviceId=DEV_CASH_TERMINAL”> . . . </if rame>
where “casehServicelFrame” IS an identifier for the first iFrame 202 (FIG. 2) for the diagnostics web application 200 and http://www.xxx.com/cashService.html?deviceID=DEV_CASH_TERMINAL” is a hyperlink that may be used to access the diagnostics web application 200.

It should also be understood that the diagnostics web application 200 and the interface web application 204 may communicate with the root web application 120 using different channels to isolate (e.g., for security purposes) the diagnostics web application 200 and the interface web application 204 from one another. For example, the diagnostics web application 200 running in the first iFrame 202 may communicate with the root web application 120 via a first channel, whereas the interface web application 204 running in the second iFrame 20 may communicate with the root web application 120 via a second channel that is different (e.g., isolated) from the first channel.

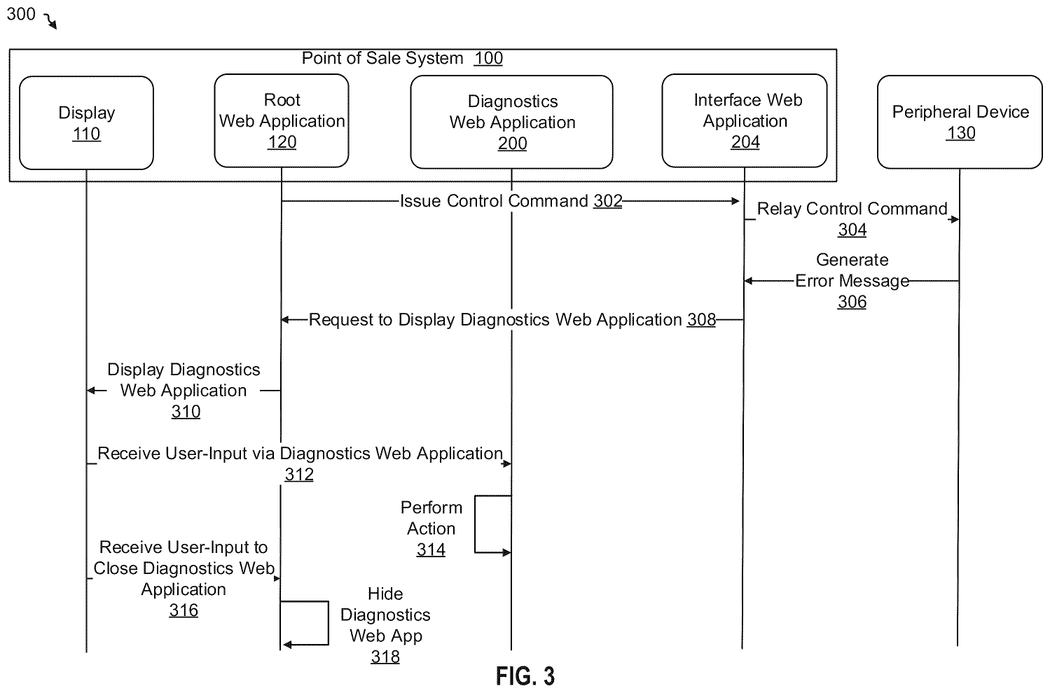

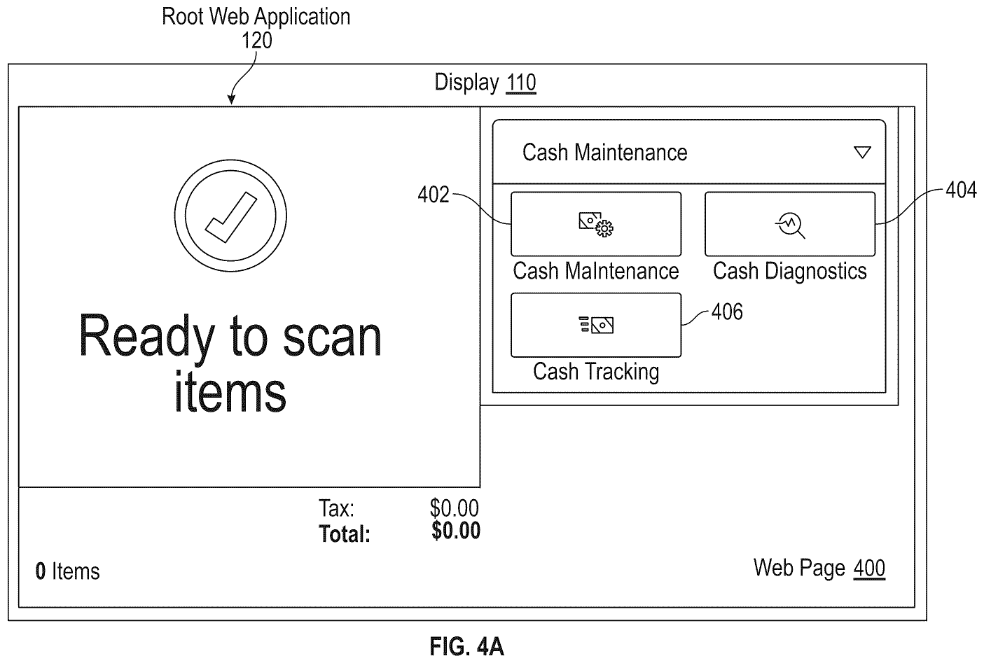

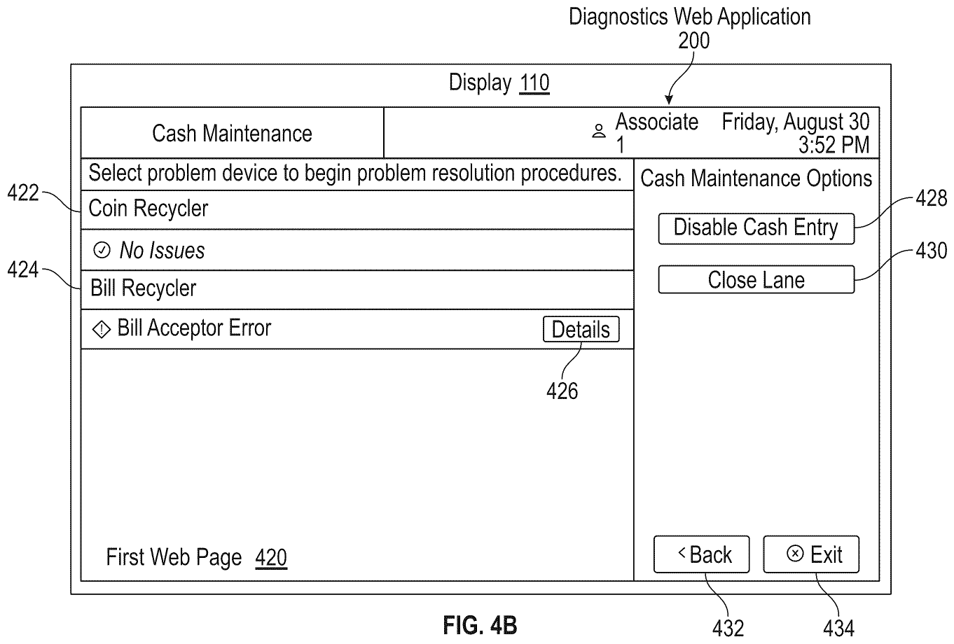

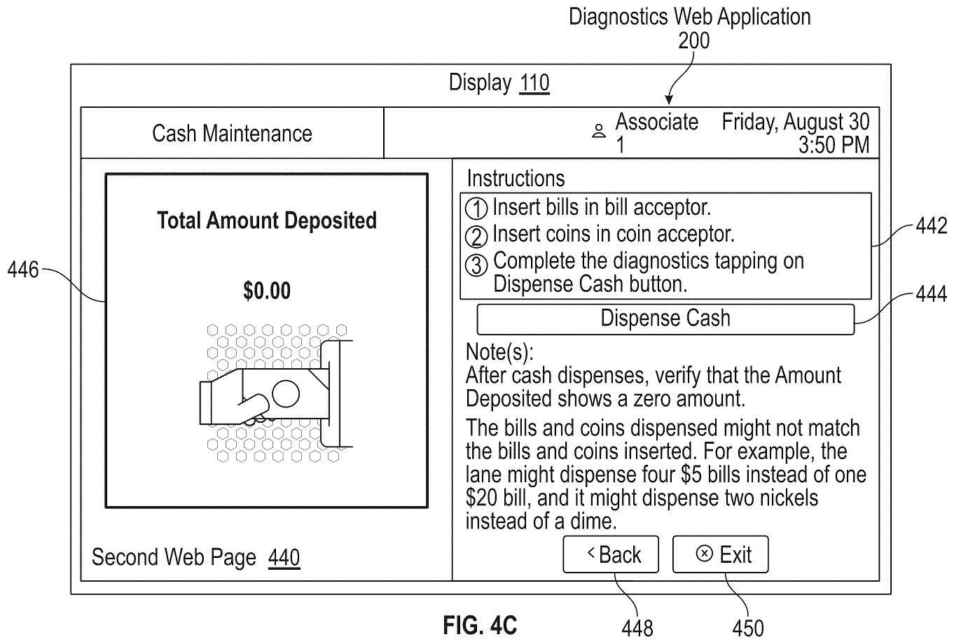

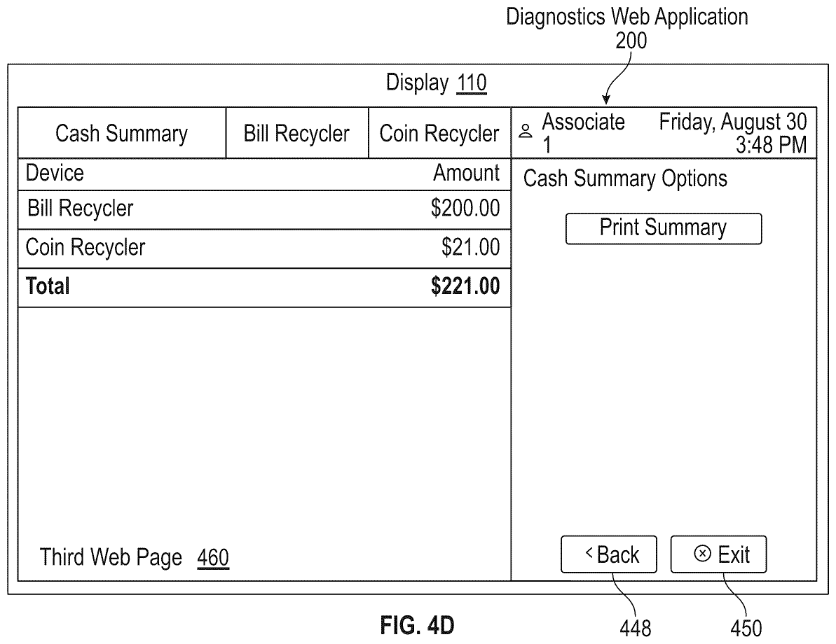

As will be discussed in more detail with reference to FIGS. 3 and 4A-4D, the diagnostics web application 200 may typically be hidden from view within the root web application 120. However, the diagnostics web application 200 may become visible within the root web application 120 when, for example, the peripheral device encounters an error while attempting to perform a requested action, such as accepting a note (e.g., check) or money (e.g., bills, coins) from a user or dispensing a requested amount of money to the user.

FIG. 3 depicts a sequence diagram 300 illustrating use of the diagnostics web application 200 according to some embodiments of the present disclosure.

At 302, the root web application 120 may issue a control command to the interface web application 204 running in the second iFrame of the root web application 120. For example, the control command may be generated by a user interacting with one or more user interface elements associated with the webpage for the root web application 120 to request the peripheral device 130 perform an action (e.g., accept a check/money or dispense money).

At 304, the interface web application 204 may provide the issued control command to the peripheral device 130. In some embodiments, the peripheral device 130 may process the control command to determine what action (e.g., collect, dispense) the peripheral device 130 is being requested to perform. For example, the CPU 134 (FIG. 1) of the computing system 132 (also FIG. 1) included onboard the peripheral device 130 may process the control command to determine what action the peripheral device 130 is being requested to perform.

At 306, the peripheral device 130 may generate an error message in response to receiving the control command. For example, the peripheral device 130, specifically the CPU 134 of the computing system 132 thereon, may generate the error message while attempting to perform the requested action.

At 308, the interface web application 204 receives the error message generated by the peripheral device 130 and, in response to receiving the error message, generates a request to make the diagnostics web application 200 visible within the root web application 120. For example, the interface web application 204 may provide the request to make the diagnostics web application 200 visible to the root web application (e.g., via the second channel).

At 310, the root web application 120 may make the diagnostics web application 200 visible within the root web application 120. More specifically, a user may interact with a webpage associated with the root web application 120 to navigate to the diagnostics web application 200 without leaving the root web application 120. Once the user navigates to the diagnostics web application 200, the user may interact with the diagnostics web application 200, specifically one or more webpages thereof, to troubleshoot the error message generated by the peripheral device 130.

At 312, the user may provide input to the diagnostics web application 200 via the display 110. More specifically, the user may select one or more user-interface elements associated with the webpage of the diagnostics web application 200. In some embodiments, the user input may include data identifying a particular user interface element the user selected while interacting with the diagnostics web application 200.

At 314, the diagnostics web application 200 may perform an action in response to the user input received at 312. In some embodiments, the action performed at 314 may include navigating to another webpage of the diagnostics web application 200 based on the particular user interface element of the diagnostics web application 200 that the user selected at 312.

In some embodiments, the user-input provided by the user at 312 may prompt the diagnostics web application to obtain information from the peripheral device 130. To obtain the information, the diagnostics web application 200 may communicate the request to the interface web application 204 via the root web application 120. For example, the diagnostics web application 200 may provide the request to the root web application 120 via the first channel (e.g., discussed above with reference to FIG. 2) and the root web application 120 may provide the request to the interface web application 204 via the second channel (e.g., also discussed above with reference to FIG. 2). Furthermore, the interface web application 204 may receive the requested information from the peripheral device 130 and may communicate the requested information to the diagnostics web application in the same manner (e.g., via the root web application 120).

It should be understood that operations 312 and 314 may be performed iteratively until the user is finished interacting with the diagnostics web application 200 to troubleshoot the error message generated by the peripheral device 130 in response to the control command issued at 302.

At 316, the user may, in some embodiments, provide input associated with stopping (e.g., closing) the webpage of the diagnostics web application 200. For example, the user may select a particular user interface element within the webpage to stop the diagnostics web application 200. In other embodiments, a request to close the diagnostics web application 200 within the root web application 120 may be generated after a predetermined amount of time has lapsed since the user last interacted with the diagnostics web application 200.

At 318, the root web application 120 may close the diagnostics web application 200 such that the diagnostics web application 200 is invisible (e.g., hidden from view) within the webpage of the root web application 120. In this manner, the diagnostics web application 200 may no longer be visible to the user within the webpage associated with the root web application 120.

FIG. 4A illustrates the root web application 120 according to one or more embodiments of the present disclosure. More specifically, FIG. 4A illustrates a webpage 400 of the root web application 120.

As illustrated, the webpage 400 of the root web application 120 may include a first user interface element 402, a second user interface element 404, and a third user interface element 406. The first user interface element 402, the second user interface element 404, and the third user interface element 406 may, upon being selected by a user interacting with the webpage 400 root web application 120, direct the user to different webpages of the diagnostics web application 200.

FIG. 4B depicts a first webpage 420 of the diagnostics web application 200 according to one or more embodiments of the present disclosure. As illustrated, a user may navigate from the webpage 400 of the root web application 120 depicted in FIG. 4A to the first webpage 420 of the diagnostics web application 200 by selecting the first user interface element 402 within the webpage 400 of the root web application 120.

The first webpage 420 of the diagnostics web application 200 may include a status of different components of the peripheral device 130. For example, as illustrated in FIG. 4B, the first webpage 420 of the diagnostics web application 200 may indicate that a first component 422 (e.g., labeled “coin recycler”) of the peripheral device 130 currently has no issues. The first webpage 420 of the diagnostics web application 200 may further indicate that a second component 424 (e.g., labeled “bill recycler”) of the peripheral device 130 currently has an issue (e.g., labeled bill acceptance error).

In some embodiments, the first webpage 420 of the diagnostics web application 200 may include a first user interface element 426 that a user may select (e.g., click, touch) to obtain details regarding the current issue with the second component 424 of the peripheral device 130.

In some embodiments, the first webpage 420 of the diagnostics web application 200 may include a second user interface element 428 associated with taking a first action in response to the issue with the second component 424 of the peripheral device 130. The second user interface element 428 may cause the peripheral device 130 to disable functionality that involves the second component 424 of the peripheral device 130. For example, the second component 424 of the peripheral device 130 may be used to recycle money, specifically dollar bills. Thus, by selecting the second user interface element 428 of the first webpage 420, the user may disable (e.g., by sending a control signal from to the peripheral device 130 via the interface web application 204) components of the peripheral device 130 that are involved with accepting money being input by a user interacting with the peripheral device 130.

In some embodiments, the first webpage 420 of the diagnostics web application 200 may include a third user interface element 430 associated with taking a second action in response to the issue with the second component 424 of the peripheral device 130. The third user interface element 430 may cause the point of sale system (e.g., the point of sale system 100 of FIG. 1) to go offline such that the point of sale system 100 and the peripheral device 130 cannot be used to scan and pay for items.

In some embodiments, the first webpage 420 of the diagnostics web application 200 may include a fourth user interface element 432 and a fifth user interface element 434. The fourth user interface element 432 may be selected by the user to navigate back to the webpage 400 of the root web application 120, whereas the fifth user interface element 434 may be selected by the user to close (e.g., stop) the diagnostics web application 200.

FIG. 4C depicts a second webpage 440 of the diagnostics web application 200. As illustrated, a user may navigate from the webpage 400 of the root web application 120 depicted in FIG. 4A to the second webpage 440 of the diagnostics web application 200 by selecting the second user interface element 404.

In some embodiments, the second webpage 440 of the diagnostics web application 200 may include instructions 442 for checking the accuracy of the peripheral device 130 in verifying an amount of money deposited by a user. For example, the instructions 442 may prompt the user to insert a bill into a bill collector (e.g., money/note collector 140 in FIG. 1) and also insert a coin into a coin collector (e.g., money/note collector 140 in FIG. 1). After inserting the bill and coin into the bill collector and coin collector, respectively, the instructions 442 may prompt the user to select a first user interface element 444 (e.g., labeled “Dispense Cash”) to cause the peripheral device 130 to dispense the cash (e.g., bill and coin) the user input into the peripheral device 130. In this manner, the user may interact with the peripheral device 130 to confirm the peripheral device 130 is functioning properly.

In some embodiments, the second webpage 440 of the diagnostics web application 200 may include a message 446 indicating how much money the user deposited into the peripheral device 130.

In some embodiments, the second webpage 440 of the diagnostics web application 200 may include a second user interface element 448 and a third user interface element 450. The second user interface element 448 may be selected by the user to navigate back to the webpage 400 of the root web application 120, whereas the third user interface element 450 may be selected by the user to close (e.g., stop) the diagnostics web application 200.

FIG. 4D depicts a third webpage 460 of the diagnostics web application 200 according to one or more embodiments of the present disclosure. As illustrated, a user may navigate from the webpage 400 of the root web application 120 depicted in FIG. 4A to the third webpage 460 of the diagnostics web application 200 by selecting the third user interface element 406.

In some embodiments, the third webpage 460 of the diagnostics web application 200 may include a summary of an amount of money the peripheral device 130 is currently holding. For example, the summary may indicate a monetary amount of bills collected by the bill collector (e.g., money/note collector 140 in FIG. 1) of the peripheral device 130 and may further indicate a monetary amount of coins collected by the coin collector (e.g., money/note collector 140 in FIG. 1) of the peripheral device 130.

In some embodiments, the third webpage 460 of the diagnostics web application 200 may include a first user interface element 462 and a second user interface element 464. The first user interface element 462 may be selected by the user to navigate back to the webpage 400 of the root web application 120, whereas the second user interface element 464 may be selected by the user to close (e.g., stop) the diagnostics web application 200.

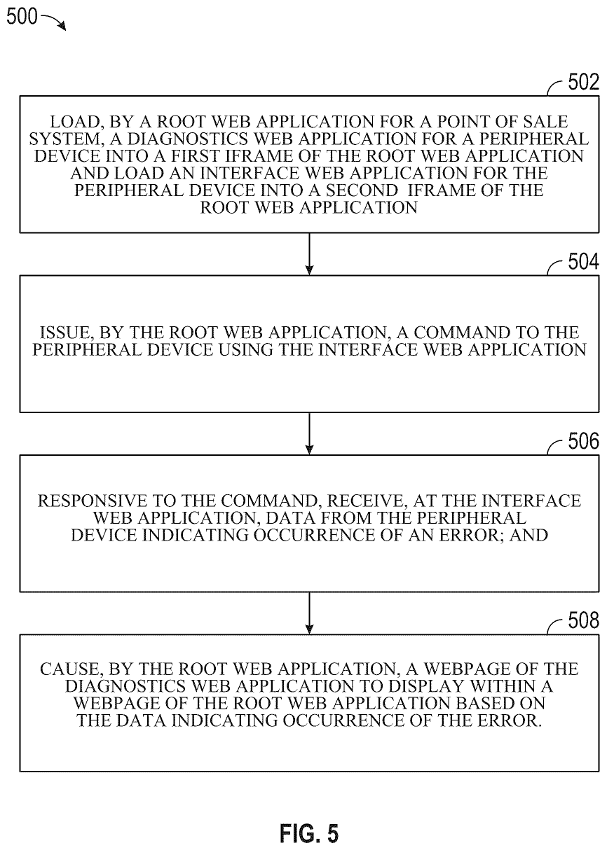

FIG. 5 is a flow diagram of a method 500 according to one or more embodiments of the present disclosure. The operations of the method 500 may be performed using the point of sale system 100 and peripheral device 130 discussed above with reference to FIG. 1.

At 502, the method 500 can include loading, byaroot web application, a diagnostics web application for a peripheral device into a first iFrame of the root web application and loading an interface web application for the peripheral device into a second iFrame of the root web application.

At 504, which occurs subsequent to (502), the method 500 can include issuing, by the root web application, a command to the peripheral device using the interface web application.

At 506, the method 500 can include, in response to issuing the command, receiving, at the interface web application, data from the peripheral device. Furthermore, the data can indicate occurrence of an error on the peripheral device. For example, in some embodiments, the command can be associated with requesting a function (e.g., accept cash or dispense cash) of the peripheral device, and the error can be the inability of the peripheral device, specifically a component thereof, to perform the requested function.

At 508, the method 500 can include causing, by the root web application, a webpage of the diagnostics web application to display within a webpage of the root web application based on the data indicating occurrence of the error. For example, a user may, in response to the occurrence of the error on the peripheral device, interact with a user interface element of the webpage of the root web application to navigate to the diagnostics web application, such as the first webpage 420 in FIG. 4B, the second webpage 440 in FIG. 4C, or the third webpage 460 in FIG. 4D.

In some embodiments, the method 500 can include receiving, at the root web application, user input from the diagnostics web application. The method 500 can further include, in response to receiving the user input, stop displaying the diagnostics web application within the root web application.

In some embodiments, the method 500 can include receiving, at the root web application, user input from the diagnostics web application. The method 500 can further include disabling a functionality of the peripheral device based on the user input.

In some embodiments, disabling the functionality of the peripheral device can include generating, at the diagnostics web application, a signal associated with disabling the functionality of the peripheral device. The method 500 can further include transmitting, by the diagnostics web application, the signal to the peripheral device. The method 500 can further include transmitting the signal from the diagnostics web application to the root web application by transmitting the signal from the root web application to the interface web application via a second channel that is different from the first channel and transmitting the signal from the interface web application to the peripheral device.d

The descriptions of the various embodiments have been presented for purposes of illustration, but are not intended to be exhaustive or limited to the embodiments disclosed. Instead, any combination of the noted features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to one or more embodiments, other and further embodiments may be devised without departing from the basic scope thereof, and the scope thereof is determined by the claims that follow.

1. A method comprising:
loading, by a root web application for a point of sale system, a diagnostics web application for a peripheral device connected to the point of sale system into a first iFrame of the root web application and loading an interface web application for the peripheral device into a second iFrame of the root web application;
issuing, by the root web application, a disable command for the peripheral device connected to the point of sale system using the interface web application loaded into the second iFrame of the root web application;
generating, at the diagnostic web application loaded into the first iFrame, a disable signal at the diagnostic web application;
responsive to the issuing the disable command:
receiving, at the interface web application, data from the peripheral device indicating occurrence of an error,
transmitting the disable signal from the diagnostics web application loaded into the first iFrame to the interface web application loaded into the second iFrame,
deactivating the peripheral device connected to the point of sale system responsive to receiving the disable signal; and
causing, by the root web application, a webpage of the diagnostics web application to display within a webpage of the root web application based on the data indicating occurrence of the error.

2. The method of claim 1, wherein causing the webpage of the diagnostics web application to display within the webpage of the root web application comprises receiving, via a user interface element of the webpage of the root web application, user input causing the webpage of the diagnostics web application to display within the webpage of the root web application.

3. The method of claim 1, wherein:
the root web application communicates with the diagnostics web application in the first iFrame of the root web application via a first channel; and
the root web application communicates with the interface web application in the second iFrame of the root web application via a second channel that is different from the first channel.

4. The method of claim 1, further comprising:
receiving, at the root web application, user input via the webpage of the diagnostics web application; and
responsive to the user input, causing the webpage of the diagnostics web application to stop being displayed within the webpage of the root web application.

5. The method of claim 1, further comprising:
receiving, at the root web application, user input via the webpage of the diagnostics web application; and
executing a functionality of the peripheral device connected to the point of sale system based on the user input.

6. The method of claim 5, wherein executing the functionality of the peripheral device comprises:
generating, at the diagnostics web application, a second signal associated with executing the functionality of the peripheral device connected to the point of sale system; and
transmitting, by the diagnostics web application, the second signal to the peripheral device connected to the point of sale system.

7. The method of claim 6, wherein transmitting the second signal to the peripheral device connected to the point of sale system comprises:
transmitting the second signal from the diagnostics web application to the root web application via a first channel;
transmitting the signal from the root web application to the interface web application via a second channel that is different from the first channel; and
transmitting the second signal from the interface web application to the peripheral device connected to the point of sale system.

8. The method of claim 1, wherein the webpage of the diagnostics web application comprises a first webpage of the diagnostics web application; and wherein the webpage of the root web application includes a first user interface element associated with the first webpage of the diagnostics web application, a second user interface element associated with a second webpage of the diagnostics web application, and a third user interface element associated with a third webpage of the diagnostics web application.

9. The method of claim 8, wherein:
the first webpage of the diagnostics web application indicates a status of one or more components of the peripheral device; and
the second webpage of the diagnostics web application displays instructions prompting a user to perform an action on the peripheral device to troubleshoot the error.

10. A point of sale system comprising:
one or more processors; and
memory storing computer-readable program code executable by the one or more processors to, individually or collectively, perform a method comprising:
loading, by a root web application for a point of sale system, a diagnostics web application for a peripheral device connected to the point of sale system into a first iFrame of the root web application and loading an interface web application for the peripheral device into a second iFrame of the root web application;
issuing, by the root web application, a disable command for the peripheral device connected to the point of sale system using the interface web application loaded into the second iFrame of the root web application;
generating, at the diagnostic web application loaded into the first iFrame, a disable signal at the diagnostic web application;
responsive to the issuing the disable command:
receiving, at the interface web application, data from the peripheral device indicating occurrence of an error,
transmitting the disable signal from the diagnostics web application loaded into the first iFrame to the interface web application loaded into the second iFrame,
deactivating the peripheral device connected to the point of sale system responsive to receiving the disable signal; and
causing, by the root web application, a webpage of the diagnostics web application to display within a webpage of the root web application based on the data indicating occurrence of the error.

11. The point of sale system of claim 10, wherein causing the webpage of the diagnostics web application to display within the webpage of the root web application comprises receiving, via a user interface element of the webpage of the root web application, user input causing the webpage of the diagnostics web application to display within the webpage of the root web application.

12. The point of sale system of claim 10, wherein:
the root web application communicates with the diagnostics web application in the first iFrame of the root web application via a first channel; and
the root web application communicates with the interface web application in the second iFrame of the root web application via a second channel that is different from the first channel.

13. The point of sale system of claim 10, further comprising:
receiving, at the root web application, user input via the webpage of the diagnostics web application; and
responsive to the user input, causing the webpage of the diagnostics web application to stop being displayed within the webpage of the root web application.

14. The point of sale system of claim 10, further comprising:
receiving, at the root web application, user input via the webpage of the diagnostics web application; and
executing a functionality of the peripheral device connected to the point of sale system based on the user input.

15. The point of sale system of claim 14, wherein disabling the functionality of the peripheral device comprises:
generating, at the diagnostics web application, a second signal associated with executing the functionality of the peripheral device connected to the point of sale system; and
transmitting, by the diagnostics web application, the second signal to the peripheral device connected to the point of sale system.

16. The point of sale system of claim 15, wherein transmitting the signal to the peripheral device comprises:
transmitting the signal from the diagnostics web application to the root web application via a first channel;
transmitting the signal from the root web application to the interface web application via a second channel that is different from the first channel; and
transmitting the signal from the interface web application to the peripheral device connected to the point of sale system.

17. The point of sale system of claim 10, wherein the webpage of the diagnostics web application comprises a first webpage of the diagnostics web application; and wherein the webpage of the root web application includes a first user interface element associated with the first webpage of the diagnostics web application, a second user interface element associated with a second webpage of the diagnostics web application, and a third user interface element associated with a third webpage of the diagnostics web application.

18. The point of sale system of claim 17, wherein:
the first webpage of the diagnostics web application indicates a status of one or more components of the peripheral device; and
the second webpage of the diagnostics web application displays instructions prompting a user to perform an action on the peripheral device to troubleshoot the error.

19. The point of sale system of claim 10, wherein the peripheral device is configured to accept currency, dispense currency, or both.

20. A computer-readable storage medium having computer-readable program code embodied therewith, the computer-readable program code executable by one or more computer processors to, individually or collectively, perform a method comprising:
loading, by a root web application for a point of sale system, a diagnostics web application for a peripheral device connected to the point of sale system into a first iFrame of the root web application and loading an interface web application for the peripheral device into a second iFrame of the root web application;
issuing, by the root web application, a disable command to for the peripheral device connected to the point of sale system using the interface web application loaded into the second iFrame of the root web application;
generating, at the diagnostic web application loaded into the first iFrame, a disable signal at the diagnostic web application;
responsive to the issuing the disable command:
receiving, at the interface web application, data from the peripheral device indicating occurrence of an error,
transmitting the disable signal from the diagnostics web application loaded into the first iFrame to the interface web application loaded into the second iFrame,
deactivating the peripheral device connected to the point of sale system responsive to receiving the disable signal; and
causing, by the root web application, a webpage of the diagnostics web application to display within a webpage of the root web application based on the data indicating occurrence of the error.
